(19) United States
(12) Patent Application Publication
(10) Pub. No.: US 2014/0326836 A1
(43) Pub. Date: Nov. 6, 2014

(54) CABLE FIXING CLIP FOR PREVENTING REVERSE-ASSEMBLY

(71) Applicant: Kyung Chang Industrial Co., Ltd., Daegu (KR)

(72) Inventors: Kyujung Kim, Daegu (KR); Jungwoo Woo, Daegu (KR)

(21) Appl. No.: 13/919,292

(22) Filed: Jun. 17, 2013

(30) Foreign Application Priority Data
May 6, 2013 (KR) 10-2013-0050454

(51) Int. Cl. F16L 3/12

(52) U.S. Cl. CPC F16L 3/12
USPC 248/65

(57) ABSTRACT

Disclosed therein is a cable fixing clip for preventing reverse-assembly. The cable fixing clip includes: a body having a cable assembly receiving portion formed at a lower portion; an elastic support connected to the body in such a fashion that a fitting recess to which the bracket is inserted is formed between the body and the elastic support; and a reverse-assembly preventing rib mounted at least one of the body and the elastic support.

### CROSS-REFERENCE TO RELATED APPLICATION

This application claims priority to Korean Application No. 10-2013-0050454 filed on May 6, 2013, which is incorporated herein by reference.

### TECHNICAL FIELD

The present invention relates to a clip for fixing a cable to a bracket of a vehicle, and more particularly, to a cable fixing clip which can prevent reverse-assembly.

### BACKGROUND ART

Various kinds of cables for transmitting a manipulation force are used in a vehicle. The cables are provided at a frame of the vehicle or fixed to a bracket fixed to the frame. Socket for guiding the cable is used in order to prevent the cable from being bent or worn out, and clip member is widely used as mounting means for mounting the socket and the cable to the bracket.

Korean Utility Model Registration No. 20-0275868 published on May 16, 2002 discloses an example of the clip. However, the clip according to the prior art has a problem that the clip and the socket may be reversely assembled to the bracket inadvertently. In the event of reverse-assembly, the clip and the socket may be separated from each other during traveling of a vehicle and it is impossible to normally transmitting the manipulation force through the cable.

### SUMMARY

Accordingly, the present invention has been made to solve the above-mentioned problems of the prior arts, and it is an object of the present invention to provide a cable fixing clip for preventing reverse-assembly.

To achieve the above objects, the present invention provides a cable fixing clip for preventing reverse-assembly including: a body having a cable assembly receiving portion formed at a lower portion; an elastic support connected to the body in such a fashion that a fitting recess to which the bracket is inserted is formed between the body and the elastic support; and a reverse-assembly preventing rib mounted at least one of the body and the elastic support.

The cable fixing clip further includes a socket through which a cable of a cable assembly passes, and the socket has a stopper provided at a position beyond which the elastic support cannot be bent so that reverse-assembly is prevented.

According to the present invention, the clip for fixing the cable assembly to the bracket is not assembled reversely.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a perspective view showing a clip according to a first embodiment of the present invention fastened to a bracket;

FIG. 2 is an exploded perspective view of a clip assembly according to the first embodiment;

FIG. 3 is a side view of the clip assembly according to the first embodiment;

FIG. 4 is a perspective view showing a clip according to a second embodiment of the present invention fastened to a bracket; and

FIG. 5 is an exploded perspective view of a clip assembly according to the second embodiment.

### DETAILED DESCRIPTION

Reference will be now made in detail to the embodiment of the present invention with reference to the attached drawings. For understanding of the technical idea of the present invention, descriptions of components which have no direct relationship with the present invention will be omitted. Even though there is no detailed description of the components, those skilled in the art can easily understand the present invention without any difficulty.

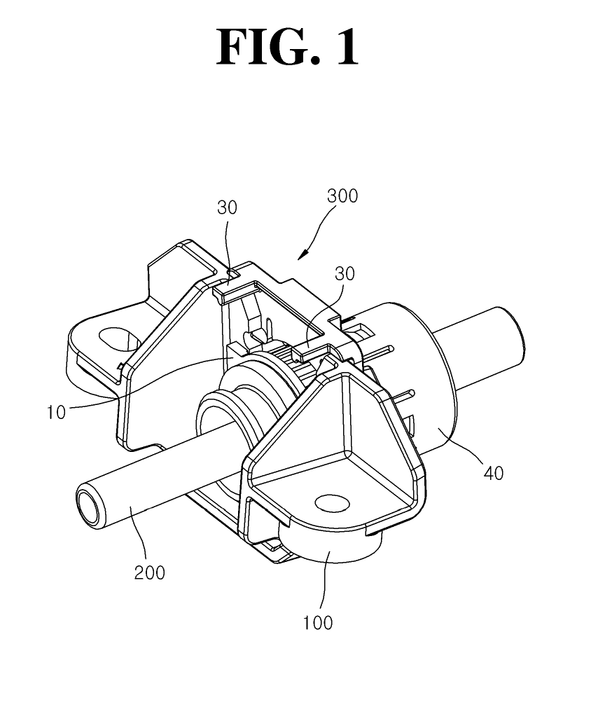

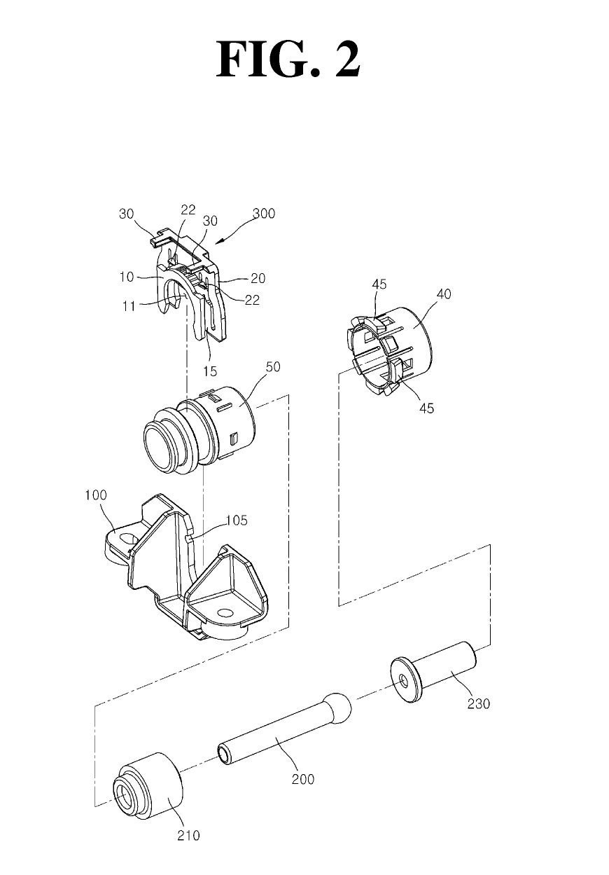

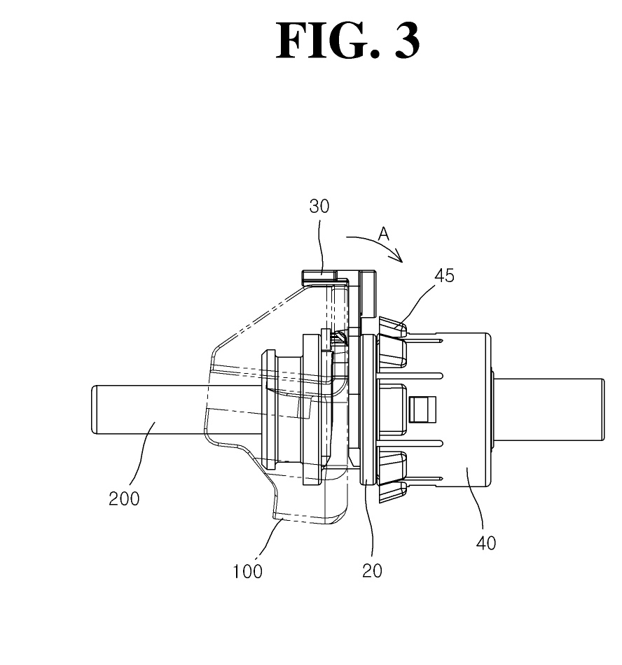

FIG. 1 is a perspective view showing a clip assembly of a first embodiment fastened to a bracket; FIG. 2 is an exploded perspective view of the clip assembly; and FIG. 3 is a side view of the clip assembly.

The clip 300 includes a body 10 having a cable assembly receiving portion 11 formed at a lower portion thereof; an elastic support 20 connected to the body 10 in such a fashion that a fitting recess 15 to which the bracket 100 is inserted is formed between the body 10 and the elastic support 20; and a reverse-assembly preventing rib 30.

The elastic support 20 may be bent in A direction (See FIG. 3) and has engagement protrusion 22. The engagement protrusion 22 is engaged with engagement recess 105 of the bracket 100.

FIGS. 1 to 3 show that the reverse-assembly preventing rib 30 is provided at the elastic support 20. However, the reverse-assembly preventing rib 30 may be provided at the body 10. Alternatively, the rib 30 may be provided at both of the elastic support 30 and the body 10.

A socket 40 for guiding a cable 200 has a stopper 45. The stopper 45 is provided at an end position beyond which the elastic support 20 cannot be bent so that reverse-assembly is prevented. Bending of the elastic support 20 is blocked at the end position.

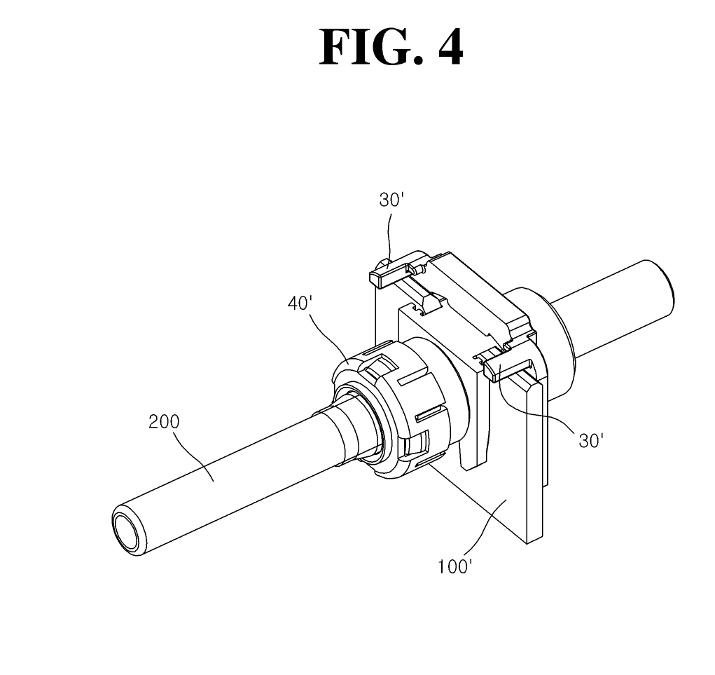

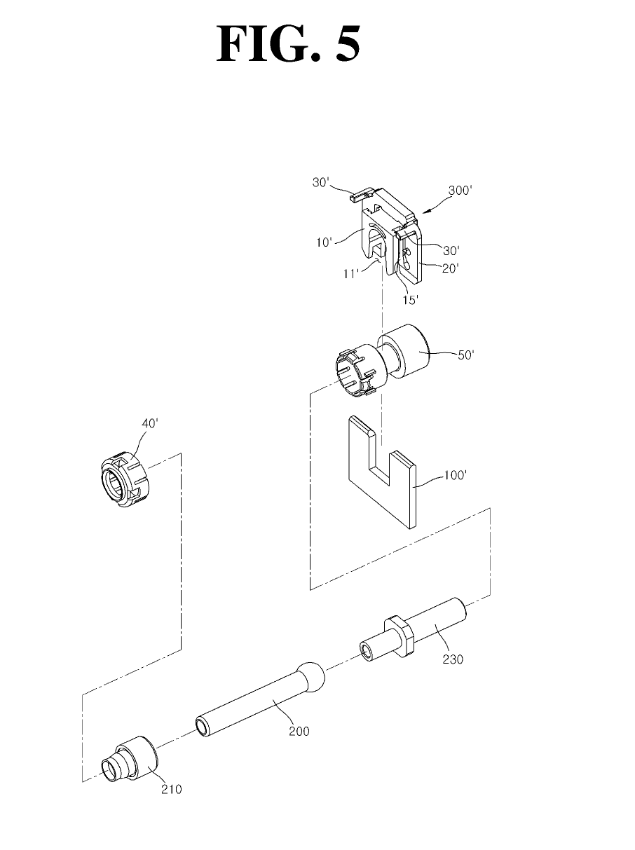

FIG. 4 is a perspective view showing a state where a clip 300′ of a second embodiment is fastened to a bracket 100′, and FIG. 5 is an exploded perspective view of the state. The clip 300′ is different from the clip 300 in that the clip 300′ is fastened to the bracket 100′ without bending an elastic support 20′.

Next, fastening of the clips 300 and 300′ to the bracket will be described.

If the clip 300 reversely approaches to the bracket 100 for assembly, the bracket 100 is blocked by the reverse-assembly preventing rib 30, thereby preventing reverse-assembly. Moreover, in the event that the elastic support 20 has to be bent for assembly in A direction of

FIG. 3, the bending of the elastic support 20 is blocked at the end position by the stopper 45. That is, the maximum bending of the elastic support 20 does not form a gap where the bracket 100 is inserted for assembly.

The reverse-assembly of the clip 300′ illustrated in FIGS. 4 and 5 can be prevented by a reverse-assembly preventing rib 30′.

While the preferred embodiment of the present invention has been particularly described with reference to the attached drawings, it will be understood that the scope of the present invention is determined by the following claims and is not limited by the described embodiment and/or drawings. Moreover, it would be understood to those skilled in the art that the modifications and equivalents of the present invention belong to the scope of the present invention.

What is claimed is:

1. A cable fixing clip for preventing reverse-assembly comprising:
a body having a cable assembly receiving portion formed at a lower portion;
an elastic support connected to the body in such a fashion that a fitting recess to which the bracket is inserted is formed between the body and the elastic support; and
a reverse-assembly preventing rib mounted at least one of the body and the elastic support.

2. The cable fixing clip according to claim 1, further comprising:
a socket through which a cable passes, wherein the socket comprises a stopper provided at a position beyond which the elastic support cannot be bent so that reverse-assembly is prevented.
